(19) United States
(12) Patent Application Publication
(10) Pub. No.: US 2008/0298493 A1
(43) Pub. Date: Dec. 4, 2008

(54) N-CANDIDATE DEPTH-FIRST DECODING

(75) Inventors: Hun-Seok KIM, Los Angeles, CA (US); Seok-Jun LEE, Allen, TX (US); Manish GOEL, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/756,368

(22) Filed: May 31, 2007

(51) Int. Cl. H04L 5/12

(52) U.S. Cl. 375/261; 375/260

(57) ABSTRACT

The problem outlined above may at least in part be addressed by N-Candidate Depth-First Decoding methods and systems that employ such methods. In some embodiments, the method includes receiving data representing a vector of receive signals detected by multiple receive transceivers; performing an N-candidate, depth-first search on the data to obtain an estimated constellation point; and providing a user data stream based at least in part on the estimated constellation point. In some embodiments the system includes a multiple-input multiple-output decoder. The decoder is configured to perform an N-candidate, depth-first search as part of converting a receive signal into a data stream.

### BACKGROUND

As wireless technology provides faster and more inexpensive devices, it enables people to be more mobile. Such mobility is desirable to many because it enables better collaboration and more efficient transactions.

To improve the performance of wireless devices, and hence improve mobility, designers are turning to the use of multiple-input multiple-output (“MIMO”) systems. MIMO systems have more than one transmitter and more than one receiver, and hence, more than one wireless channel. Such systems work well with existing orthogonal frequency-division multiplexing (“OFDM”) methods of transmission because the orthogonal nature of the carriers helps to prevent interference between the adjacent carriers.

At any given frequency, channel output y is related to channel input s by a matrix H such that:

y=Hs+n, (1)

where s, y and n are vectors. The input vector s has M_{T} elements and the output vector y and noise vector n has M_{R} elements. M_{T} and M_{R} are the number of transmit and receive transceivers, respectively. Input vector s is a member of a signal constellation having M_{T} dimensions (Ω^{M}_{T}). Because of this dimensionality, the decoding problem may become computationally demanding. For example, an algorithm to decode y in order to determine which constellation point S was sent over the wireless channel requires solving the equation

$$\hat{S} = {\text{arg} min}_{s ∈ {Ω}^{{M}_{T}}} {‖ y - Hs ‖}^{2} . \qquad ( 2 )$$

This problem has complexity that grows exponentially with the number of transmit transceivers M_{T}. For instance, with 4 transmit transceivers (M_{T}=4) using 16-QAM, there are in each symbol interval 16⁴ or 65,536 constellation points in each frequency bin to be searched in order to locate the signal. Any reduction in this complexity would be advantageous.

### SUMMARY

The problem outlined above may at least in part be addressed by N-Candidate Depth-First Decoding methods and systems that employ such methods. In some embodiments, the method includes receiving data representing a vector of receive signals detected by multiple receive transceivers; performing an N-candidate, depth-first search on the data to obtain an estimated constellation point; and providing a user data stream based at least in part on the estimated constellation point.

In some embodiments the system includes a multiple-input multiple-output decoder. The decoder is configured to perform an N-candidate, depth-first search as part of converting a receive signal into a data stream.

### BRIEF DESCRIPTION OF THE DRAWINGS

For a more complete understanding of the present disclosure and the advantages thereof, reference is now made to the accompanying drawings and detailed description, wherein like reference numerals represent like parts:

FIG. 1 illustrates a wireless channel transmission in accordance with some embodiments of the present disclosure;

FIG. 2 illustrates a wireless multiple-input multiple-output (“MIMO”) interface in accordance with some embodiments of the present disclosure;

FIG. 3 illustrates data flow through a MIMO system in accordance with some embodiments of the present disclosure;

FIG. 4 is a block diagram of a transmit transceiver in accordance with some embodiments of the present disclosure;

FIG. 5 is a block diagram of a receive transceiver in accordance with some embodiments of the present disclosure;

FIG. 6 illustrates a constellation of possibly transmitted signals in accordance with some embodiments of the present disclosure;

FIG. 7 illustrates N-candidate, depth-first decoding and a node tree in accordance with some embodiments of the present disclosure;

FIG. 8 is a block diagram of a decoder module and other connections in accordance with some embodiments of the present disclosure;

FIG. 9 is a chart comparing average throughput for a changing number of candidates and search methods using 64 QAM and a 4×4 transceiver configuration in accordance with some embodiments of the present disclosure;

FIG. 10 is a chart comparing average throughput for a changing number of candidates and search methods using 16 QAM and a 4×4 transceiver configuration in accordance with some embodiments of the present disclosure;

FIG. 11 is a chart comparing bit error rate (“BER”) performance for changing candidate values and search methods in accordance with some embodiments of the present disclosure;

FIG. 12 is a flow diagram illustrating a method in accordance with some embodiments of the present disclosure; and

FIG. 13 illustrates a general purpose computer system suitable for implementing some embodiments of the present disclosure.

### DETAILED DESCRIPTION

It should be understood at the outset that although an illustrative implementation appears below, the present disclosure may be implemented using any number of techniques whether currently known or later developed. The present disclosure should in no way be limited to the illustrative implementations, drawings, and techniques illustrated below, but may be modified within the scope of the appended claims along with their full scope of equivalents.

Certain terms are used throughout the following claims and discussion to refer to particular system components. This document does not intend to distinguish between components that differ in name but not function. In the following discussion and in the claims, the terms “including” and “comprising” are used in an open-ended fashion, and thus should be interpreted to mean “including but not limited to”. Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more hardware components, and may be used to refer to an electronic device or circuit, or a portion of an electronic device or circuit.

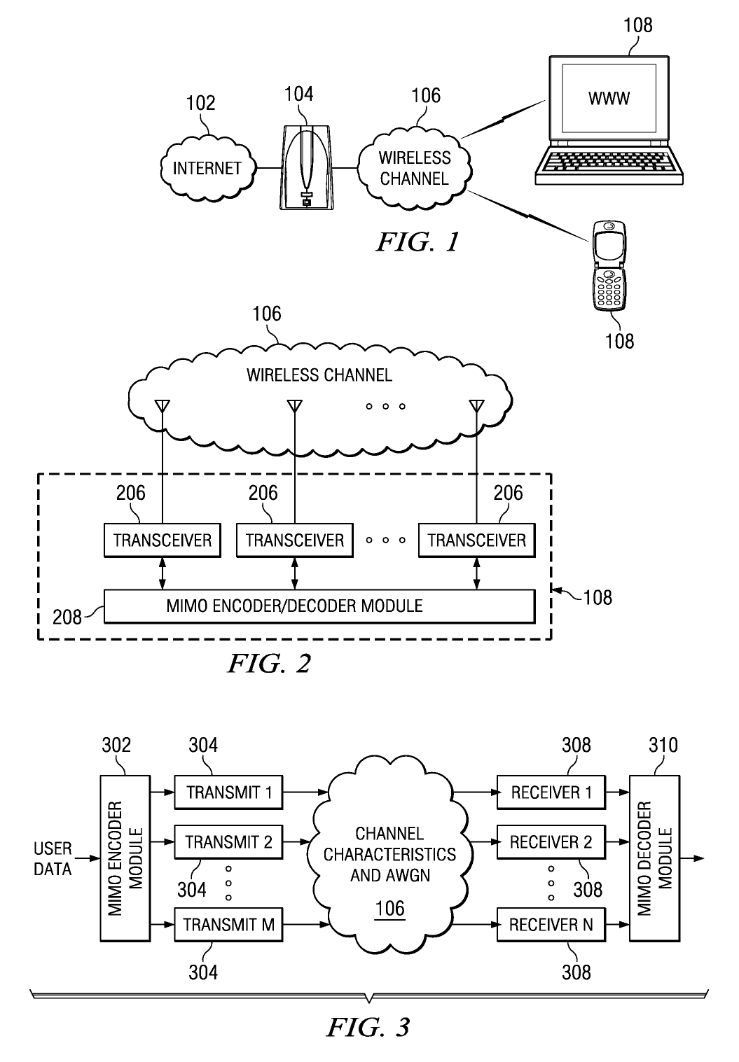

FIG. 1 illustrates an example of a wireless channel transmission: a wireless Internet connection. A combination modem/router 104 serves as a wireless access node to support a wireless channel 106 through which wireless devices 108 access the Internet 102. In some embodiments, the wireless device 108 comprises a computer. In other embodiments, the wireless device 108 comprises a personal digital assistant (PDA), cellular phone, etc. In some embodiments, the wireless device 108 is mobile (e.g., a notebook computer).

FIG. 2 illustrates how a wireless device 108 interfaces with the wireless channel 106. Transceiver input/output sources 206 send and receive data over the wireless channel 106, and couple to a multiple-input multiple-output (“MIMO”) encoder/decoder module 208, where received data are decoded or data to be transmitted are encoded, preferably using orthogonal frequency-division multiplexing (“OFDM”) encoding techniques.

FIG. 3 illustrates how data flows through a MIMO system. Some elements of FIG. 3 will be elaborated upon in the discussion of subsequent figures. Assuming OFDM using 16 quadrature amplitude modulation (“QAM”) modulation, MIMO encoder module 302 uses the data to be transmitted to modulate the amplitudes of two carrier waves, which are out of phase by 90° with respect to each other. Next, the modulated data is transmitted through transmit transceivers 304. At this point, the data is referred to as the transmitted signal or the transmitted symbol. As the transmitted signal passes through the wireless channel 106 it is altered by the transmission characteristics of the channel. The transmitted signal is also altered by noise. This noise is assumed to be additive, white, and Gaussian (“AWGN”). Thus, the signal received by the receive transceivers 308 generally appears quite different than the signal sent by the transmit transceivers 304. This altered signal is referred to as the receive signal, and is provided to a MIMO decoder module 310.

In an alternative embodiment, a different method of modulation or combination of modulation methods is used such as quadrature phase shift keying, 64-QAM, etc.

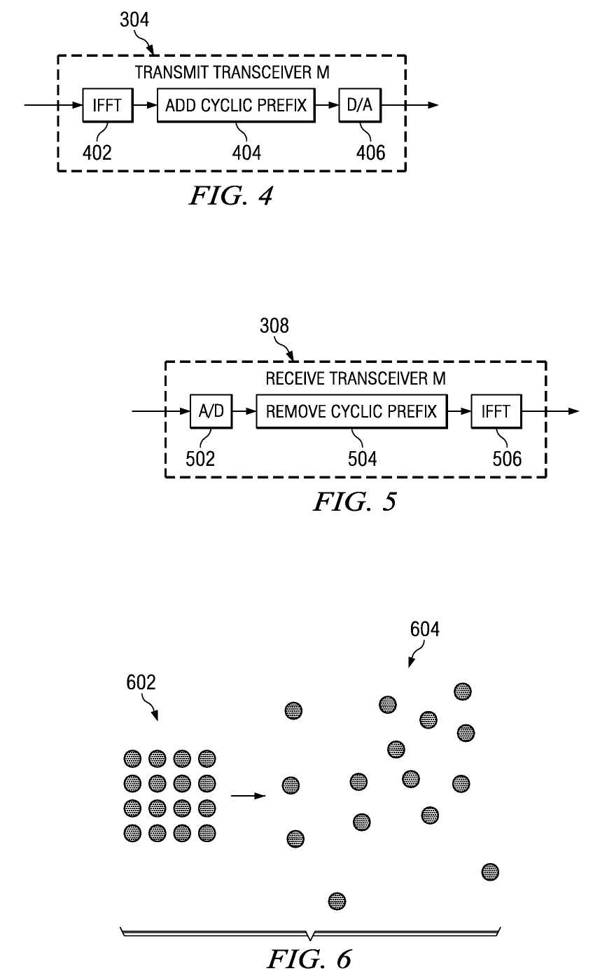

FIG. 4 is a block diagram of a transmit transceiver 304. First, data to be transmitted is transformed using an inverse fast Fourier transformation (“IFFT”) 402. Next, a cyclic prefix is added to the data 404. Finally, the data is converted from digital to analog form (“D/A”) 406 in preparation for transmission.

FIG. 5 is a block diagram of a receive transceiver. First, the received data is converted from analog to digital form (“A/D”) 502. Next, the cyclic prefix is removed from the data 504. Finally, the data is transformed using a fast Fourier transformation 506.

Before considering the MIMO decoder module 310, a discussion of decoding may be helpful. Decoding refers to the idea of estimating the transmit signal most probably sent by transmit transceivers 304 based on the signal received by receive transceivers 308. Considering a mapping of the entire constellation of possibly transmitted signals onto a coordinate system, a similarly mapped received signal will not be located exactly on the transmitted signal, as expected, because of the alteration described in the discussion of FIG. 3. The received signal will be located somewhere in between all the possibly transmitted signals. FIG. 6 illustrates a constellation of possibly transmitted signals. The constellation diagram 602 illustrates the set of signals for 16-QAM. The diagram 604 illustrates the same set after effects of the wireless channel have been taken into account.

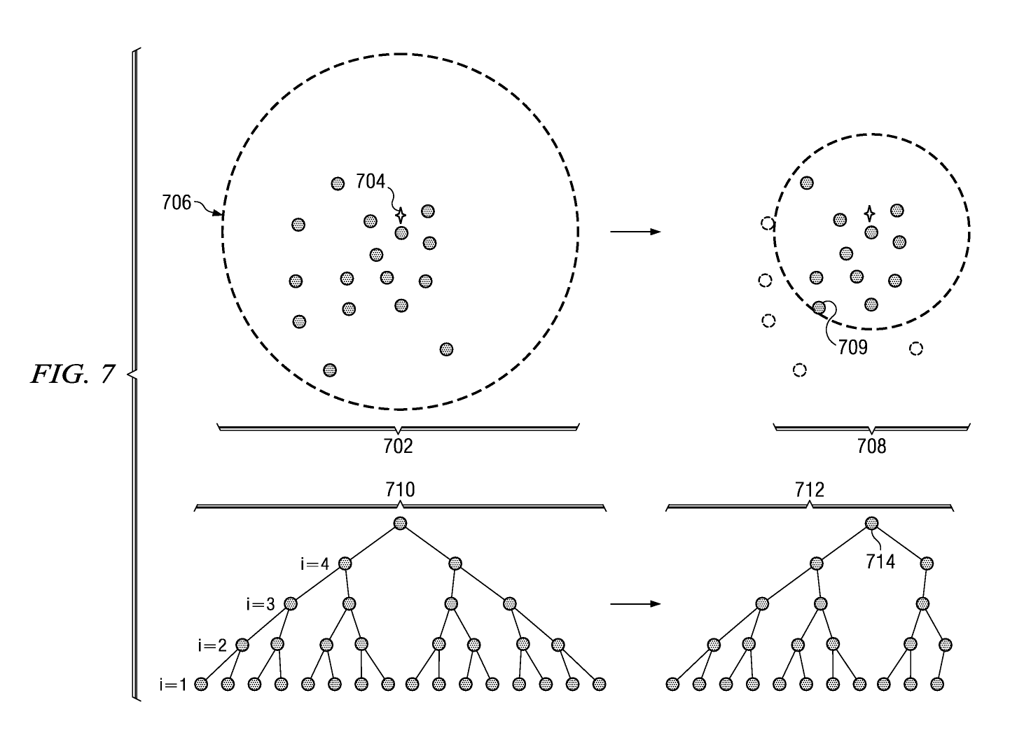

Our task is to identify which of the possibly transmitted signals was actually sent based on the received signal. Turning to FIG. 7, in diagrams 702 and 708, the received signal is represented by the star 704. If we assume that the possibly transmitted signal closest to the received signal is the signal actually sent, a logical approach would be to calculate and store the distances between the received signal and each possibly transmitted signal. We could then compare all the stored distances, and select the possibly transmitted signal corresponding to the minimum distance as the signal actually sent. However, the complexity of such an approach soon becomes unmanageable, as discussed above. One way to circumvent the complexity is to use a contracting sphere 706 to exclude possibly transmitted signals from being searched (i.e., requiring a distance to be calculated for it). Referring to diagram 708, assume for the moment that we arbitrarily select possibly transmitted signal 709 to begin the search. After calculating the distance from the received signal 704 to possibly transmitted signal 709, we may contract the radius of the sphere to just contain point 709 and exclude points with a greater distance to received signal 704. However, how can we be sure that the excluded points are indeed further away than point 709 without resorting to calculating the distances of those points?

The answer lies in the idea of partial Euclidean distances, or metrics. Referring to diagram 710, if we build a node tree such that each node corresponds to one possibly transmitted signal, and the number of levels equals the number of transmit transceivers (for the complex search case), we may uniquely describe the distance to a possibly transmitted signal as the vector s in equation 1. Each node in the tree represents an element of the vector s. We may calculate partial Euclidean distances by calculating various elements of the vector s, but the vector need not be complete before we decide to remove (or “prune”) a node in the tree from further search. Nodes that are estimated to have a low likelihood of being part of the vector representing the possibly transmitted signal with the minimum distance to the received signal are pruned. Additionally, because the distances are non-negative, once we decide to prune a node from search, we may prune all successor nodes without further calculation or storage as depicted in diagram 712. We may do so because any node connected to the removed ancestor node will be farther away from the received signal, and consequently not a candidate for the signal actually sent. Hence, we need not waste computing resources calculating or storing these pruned nodes and leaves. However, by doing so, our results are only as certain as our likelihood estimation.

Diagram 712 illustrates a N-candidate, depth-first, tree traversal algorithm for pruning. If N is equal to the number of total possible constellation points, this search is an exhaustive search. Each node in the tree represents a possibly transmitted signal. Each node (except for leaf nodes) has two branches (in the BPSK case). Beginning at root node 714, the distance to each of the two nodes on the level below it are calculated. Selecting the node corresponding to the smallest distance, the distance to each of the two nodes on the level below that are calculated. This illustrates the depth-first aspect of the method, i.e., distances for successor nodes are calculated for the current node in order to reach a leaf node as soon as possible.

In a set of radii A, with N elements comprising the smallest distances, or metrics, one of the elements is flagged as being the current radius r for tree traversal. As a node is visited during the search, if the node has a smaller metric than the largest metric in the set, the set will be updated by replacing the largest metric in the set with the new metric. In one embodiment, a fast search refers to updating the current r in the set ̂ such that r always refers to the smallest value in the set. In an alternative embodiment, an exact search refers to updating the current r in the set ̂ such that r always refers to the largest value in the set. This illustrates the N-candidate aspect of the search, i.e., N is the number of metrics stored in ̂. For a large value of N, the average number of visited nodes increases dramatically, making the difference between an exact search and a fast search more pronounced. Indeed, for large N, the value of r shrinks much faster in the fast search compared to the exact search. The value for N may be selected, adjusted as needed, and optimized via simulation. Nodes with a larger metric than the current r are pruned along with any successor nodes.

It is possible that the signal actually sent does not have the smallest Euclidean distance to the received signal. However, the probability of correct detection can be maximized (without forward error correction) when we choose a signal which has the smallest distance. The probability of correct detection can be even higher if we supply as inputs to forward error correction N candidates, rather than a single candidate, and the log likelihood ratios based on the N candidates.

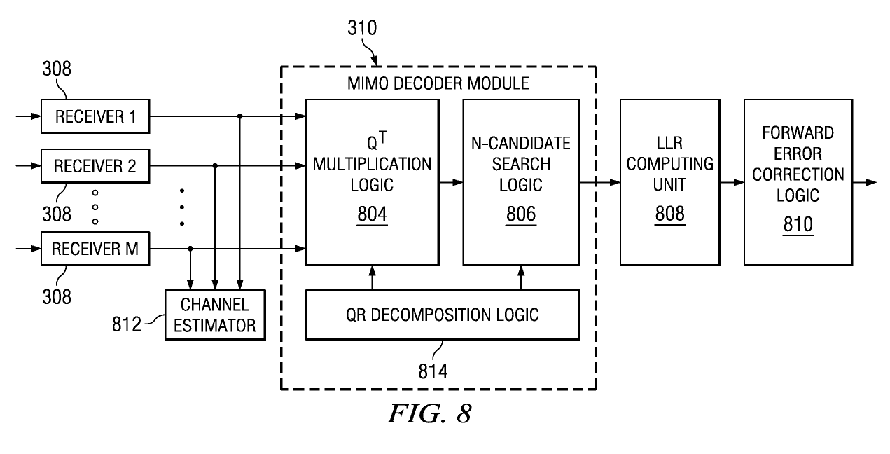

Turning to FIG. 8 and one implementation of the N-candidate, depth-first search algorithm described above, data from the receive transceivers 308 are sent to a channel estimator 812 before entering the decoder module 310. The channel estimator 812 helps ensure proper equalization, i.e., removal of inter-symbol interference (“ISI”). ISI occurs when consecutive signals sent over the wireless channel spread and disrupt each other. The channel estimator 812 also supplies the decoder module 310 with the matrix H. H is the M_{R}×M_{T} complex domain representation for the channel. The matrix H is then decomposed by QR decomposition logic 814 into matrices Q and R. Q is M_{R}×M_{T}, and has orthonormal columns. R is M_{T}×M_{T}, and upper triangular, i.e., all elements below the main diagonal are zero. Q and R are calculated such that H=QR, which may be written as

H=[Q, Q′][R, 0]^{T}, (3)

where 0 is a (M_{R}−M_{T})×M_{T} zero matrix, and Q′ is a M_{R}×(M_{R}−M_{T}) matrix. In order to mathematically apply the contracting sphere idea, a constraint may be placed on equation 2,

d(s)=∥y−Hs∥², where d(s)<r², (4)

thus pruning nodes farther away than the radius of the sphere, r. Applying the decomposition result, equation (3), to equation (4):

∥y−Hs∥<r², (5)

∥[Q, Q′,]^{T}y−[R, 0]^{T}s∥²<r² (6)

∥Q^{T}y−Rs∥²<r²−∥(Q′)^{T}y∥², (7)

c+∥Q^{T}y−Rs∥²<r², and (8)

d(s)=c+∥ŷ−Rs∥² (9)

where ŷ=Q^{T}y=Rs^{ZF}, and s^{ZF}=H⁺y. We can safely set c to be 0 because it is not a function of s, and it will be canceled in the log-likelihood-ratio approximation described below.

Multiplication logic 804 performs the multiplication by Q^{T}, and N-candidate search logic 806 implements the depth-first search on the data. The logic 806 calculates the elements for the s vector and the corresponding distance to each node by calculating a b-metric and a T-metric. The logic 806 calculates the b-metric and T-metric using

$$\begin{matrix}{b}_{i + 1} = {\hat{y}}_{i} - {\sum }_{j = i + 1}^{{M}_{T}} {R}_{ij} {s}_{j} \\ and & ( 10 ) \\ {T}_{i} = {T}_{i + 1} + {\vert {b}_{i + 1} - {R}_{ii} {s}_{i} \vert}^{2} & ( 11 )\end{matrix}$$

where T_{M}_{_{T}}=0; b_{M}_{_{T}}=ŷ_{M}_{_{T}}; T₁=∥y−Hs∥², and i=node level number as depicted in FIG. 7. In an alternative embodiment, approximations

Tᵢ=Tᵢ₊₁+|bᵢ₊₁−Rᵢᵢsᵢ|² [symbol] Xᵢ=\sqrt{Xᵢ₊₁²+|bᵢ₊₁−Rᵢᵢsᵢ|²},Xᵢ²=Tᵢ (12)

Xᵢ≈max(|Xᵢ₊₁|,|bᵢ₊₁−Rᵢᵢsᵢ|), (13)

|bᵢ₊₁−Rᵢᵢsᵢ|≈max(|Re{bᵢ₊₁−Rᵢᵢsᵢ}∥,∥Im{bᵢ₊₁−Rᵢᵢsᵢ}|) (14)

are used. The full distance d(s) from the received signal to the possibly transmitted signal is the partial Euclidean distance of a leaf, so d(s)=T₁(s). The solution is the point corresponding to the lowest T₁(s).

The log-likelihood-ratio (“LLR”) computing unit 808 computes the bit decision reliability (soft-decision) of the N-candidate search. Denoting the kₜₕ information bit as xₖ, there exists an unique mapping between the bit sequence and the transmitted signal vector: [x₁ . . . x_{M}_{_{T·log}}_{₂}_{(Q)}]^{T}=bit mapping(s), Where Q is the QAM constellation size. Equation (15) illustrates computation of the LLR based on N-candidate vectors.

$${LLR}_{k} = ln \frac{Pr \{ {x}_{k} = 1 \text{\textbar} y \}}{Pr \{ {x}_{k} = 0 \text{\textbar} y \}} = \frac{1}{2 {σ}^{2}} [ - {min}_{{s ∈ N candidates}_{with {x}_{k} = 1}} \{ {‖ y - Hs ‖}^{2} \} + {min}_{{s ∈ N candidates}_{with {x}_{k} = 0}} \{ {‖ y - Hs ‖}^{2} \} ] \qquad ( 15 )$$

The computed LLRs are then supplied to forward error correction logic (“FEC”) 810. The FEC 810 FEC performs error correction analyzing the decision reliability of coded bit sequence.

After error correction, the solution is then provided to a user via a data stream. The data stream can take any number of formats such as image data, sound data, etc. The solution can also be a piece of information that the wireless device 108 uses to ultimately cause a data stream to be provided to a user. The solution can also be a piece of information that a data stream provided to the user is based on.

Preferably, the LLR computing unit 808 and forward correction logic 810 are not part of the MIMO decoder module 310. In an alternative embodiment, they are part of the MIMO decoder module 310.

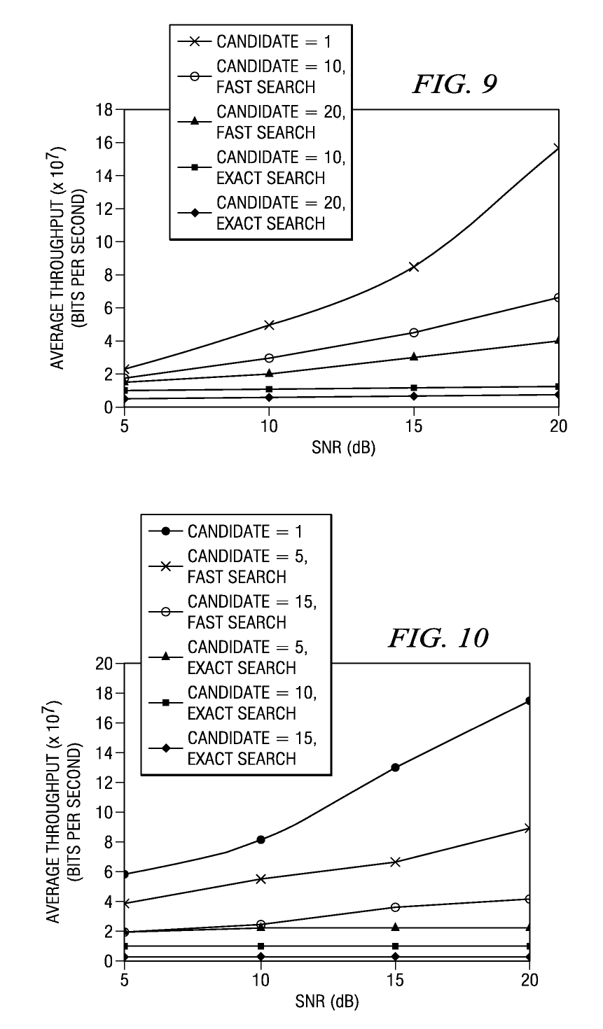

FIGS. 9 and 10 compare average throughput for changing number of candidates and search methods using 64 QAM and 16 QAM respectively. The average throughput may be calculated using

$$Φ = \frac{{M}_{T} \cdot Constellation\_Size}{E \{ D \} \cdot {t}_{CLK}} , \qquad ( 16 )$$

where E{D} is the average number of visited nodes, and t_{CLK} is the length of the critical path of the circuit. In one embodiment, a fast search refers to updating the current r in the set ̂ such that r always refers to the smallest value in the set. In an alternative embodiment, an exact search refers to updating the current r in the set ̂ such that r always refers to the largest value in the set. As can be seen, the fast search has a throughput between two to four times as high as the exact search except when the number of candidates (“Cand.”) equals 1, where a fast search is not different from an exact search.

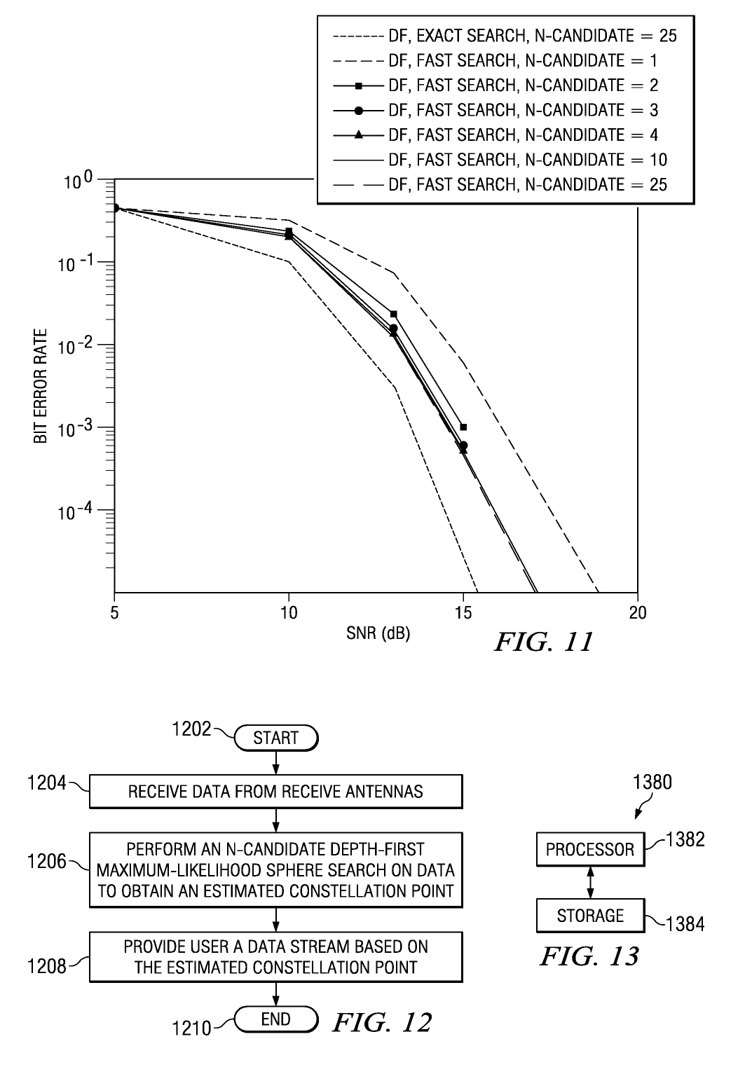

FIG. 11 depicts the slightly higher bit error rate (“BER”) incurred when using the fast search compared to the exact search for different N values. However, this slight performance degradation may be acceptable in light of significant throughput increase provided by the fast search. In this way, the performance v. throughput tradeoff may be exploited by choosing to perform an exact search or a fast search as desired.

FIG. 12 illustrates a method of implementing one embodiment of the algorithm described above. After beginning at 1202, data is received from the receive transceivers at 1204. Next, an N-candidate, depth-first search is conducted to obtain an estimation of which constellation point was sent at 1206. Next, at 1208, the user is provided a data stream based on the estimated constellation point before the end is reached at 1210.

The system described above may be implemented on a wireless device such as any general-purpose computer. FIG. 13 illustrates a typical, general-purpose computer system 1380 suitable for implementing one or more embodiments disclosed herein. In various embodiments, the storage 1384 comprises volatile memory (e.g., random access memory), non-volatile storage (e.g., Flash memory, hard disk drive, CD ROM, etc.), and combinations thereof. The storage 1384 comprises software that is executed by the processor 1382. One or more of the actions described herein are performed by the processor 1382 during execution of the software.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A method comprising:
receiving data representing a vector of receive signals detected by multiple receive transceivers;
performing an N-candidate, depth-first search on the data to obtain an estimated constellation point; and
providing a user data stream based at least in part on the estimated constellation point.

2. The method of claim 1 further comprising:
storing and updating N number of smallest node metrics as they are calculated during the search; and
updating a current sphere radius during the search to be the value of the largest stored metric.

3. The method of claim 1 further comprising:
storing and updating N number of smallest node metrics as they are calculated during the search; and
updating a current sphere radius during the search to be the value of the smallest stored metric.

4. The method of claim 3, wherein performing an N-candidate, depth-first search on the data to obtain an estimated constellation point further comprises:
pruning nodes in a node tree from further search, along with successor nodes, that have a metric greater than the current sphere radius.

5. The method of claim 1, wherein receiving data representing a vector of receive signals detected by multiple receive transceivers comprises:
receiving data representing a vector of receive signals detected by multiple receive transceivers, which outnumber transmit transceivers.

6. The method of claim 1, further comprising computing log-likelihood-ratios on the estimated constellation point using an approximation.

7. The method of claim 1, further comprising modulating the data using 16-QAM, 64-QAM, or quadrature phase shift keying, alone or in combination.

8. A mobile device comprising:
a multiple-input multiple-output decoder;
wherein the multiple-input multiple-output decoder is configured to perform an N-candidate, depth-first search as part of converting a receive signal into a data stream.

9. The mobile device of claim 8,
wherein the multiple-input multiple-output decoder is configured to store and update N number of smallest node metrics as they are calculated during the search; and
wherein the multiple-input multiple-output decoder is configured to update a current sphere radius during the search to be the value of the largest stored metric.

10. The mobile device of claim 8,
wherein the multiple-input multiple-output decoder is configured to store and update N number of smallest node metrics as they are calculated during the search; and
wherein the multiple-input multiple-output decoder is configured to update a current sphere radius during the search to be the value of the smallest stored metric.

11. The mobile device of claim 10, wherein the multiple-input multiple-output decoder is configured to prune nodes in a node tree from further search, along with any successor nodes, that have a metric greater than the current sphere radius.

12. The mobile device of claim 8, wherein receive transceivers coupled to the multiple-input multiple-output decoder outnumber transmit transceivers configured to send an encoded signal.

13. The mobile device of claim 8, further comprising a log-likelihood-ratio computing unit coupled to the multiple-input multiple-output decoder.

14. The mobile device of claim 8, wherein the data is modulated using 16-QAM, 64-QAM, or quadrature phase shift keying, alone or in combination.

15. The mobile device of claim 8, wherein the mobile device is a computer.

16. The mobile device of claim 8, wherein the mobile device is a cellular phone.

17. A system comprising:
receive transceivers; and
a multiple-input multiple-output decoder coupled to the receive transceivers, the multiple-input multiple-output decoder configured to perform an N-candidate, depth-first search as part of converting a receive signal into a data stream.

18. The system of claim 17 further comprising:
transmit transceivers configured to send data over a wireless channel to the receive transceivers; and
a multiple-input multiple-output encoder coupled to the transmit transceivers;
wherein the multiple-input multiple-output decoder is configured to store and update N number of smallest node metrics as they are calculated during the search; and
wherein the multiple-input multiple-output decoder is configured to update a current sphere radius during the search to be the value of the largest stored metric.

19. The system of claim 17 further comprising:
transmit transceivers configured to send data over a wireless channel to the receive transceivers; and
a multiple-input multiple-output encoder coupled to the transmit transceivers;
wherein the multiple-input multiple-output decoder is configured to store and update N number of smallest node metrics as they are calculated during the search; and
wherein the multiple-input multiple-output decoder is configured to update a current sphere radius during the search to be the value of the smallest stored metric.

20. The system of claim 17, wherein the multiple-input multiple-output decoder is configured to prune nodes in a node tree from further search, along with any successor nodes, that have a metric greater than the current sphere radius.

21. The system of claim 19, wherein receive transceivers outnumber the transmit transceivers.

22. The system of claim 17, further comprising a log-likelihood-ratio computing unit coupled to the multiple-input multiple-output decoder.

23. The system of claim 17, wherein the data is modulated using 16-QAM, 64-QAM, or quadrature phase shift keying, alone or in combination.
